(19) United States
(12) Patent Application Publication
(10) Pub. No.: US 2006/0250268 A1
(43) Pub. Date: Nov. 9, 2006

(54) Parameter value indicator for a parameter-measuring device

(76) Inventors: Jason Macari, Lincoln, RI (US); Steven Gibree, Foster, RI (US)

Correspondence Address: IP STRATEGIES, 12 1/2 WALL STREET, SUITE I, ASHEVILLE, NC, 28801, US

(21) Appl. No.: 11/122,786

(22) Filed: May 4, 2005

(51) Int. Cl. G08B 3/00

(52) U.S. Cl. 340/691.1

(57) ABSTRACT

A parameter value indication apparatus for a parameter measuring device includes an input port, a comparator, and a parameter value indicator. The input port receives parameter value information. The comparator compares the parameter value information with a stored threshold value and generates a first comparison result if the parameter value information is below the stored threshold value and a second comparison result if the parameter value information is above the stored threshold value. For example, the threshold can cover a range from a minimum threshold value of the parameter to a maximum threshold value of the parameter. The parameter value indicator provides a non-quantitative indication of the first and second comparison results.

### FIELD OF THE INVENTION

The present invention relates to non-quantitative value or range indicators for measuring devices.

### BACKGROUND OF THE INVENTION

Most measuring devices include a display that quantitatively expresses a value of the measured parameter. Often these displays are alphanumeric, showing the numerical value representing the measured parameter, as well as an expression of the parameter units for that value. Other displays have numerical values fixed on the display, and a movable element, such as a bar or meter, is disposed during measurement to align itself with the value that has been measured. Such measuring devices can be quite accurate, and give a precise quantitative value for the measured parameter.

Although these measuring devices provide precision in displaying a measured parameter value, the display demands a user's attention in order to acknowledge the displayed value. Some measuring devices include a hold feature by which the measured value, once stable, is locked on the display. However, a user must still look directly at the display in order to acknowledge the measured value.

In some situations, a user might want to set up a parameter measurement, particularly one in which the measurement takes some time to stabilize at an accurate value, and might turn to other tasks, or might otherwise not want to give complete attention to the measurement display. Often in these cases, a precise measurement value is not necessary. Rather, the user might want to know if the parameter measurement falls within a desired range, or crosses a particular threshold. This is particularly the case when a parameter measurement is set up, and it is known that the value of the parameter will change over time, with action required only when the measured parameter value falls outside the range or crosses the threshold.

For example, thermometers are often used as an initial diagnostic tool when a child is sick. An abnormal temperature reading can be a first indication of actual illness in a cranky infant.

Thermometers include a temperature-measuring aspect and a display aspect. That is, one portion of the thermometer is disposed in contact with or proximate to the subject, and senses the temperature at the contact/proximity point. The sensed temperature is translated in some manner, such as by physically causing a change in a controlled material or by transducing an electrical signal. This translation value is provided to a display, which in turn provides the temperature reading to an observer.

Some thermometers are provided with easy-to-read displays, which help a parent focus attention on a squirming infant while trying to measure the baby's body temperature. For example, instead of the traditional graduated mercury column display, some thermometers have a numeric display, such as an LCD panel. Still, a certain amount of attention must be paid to the display in order to read the temperature, while the parent focuses on the infant.

It would be advantageous to provide a thermometer that gives an easily discernable indication of at least an abnormal temperature reading, preferably having a display that requires no more than peripheral attention to detect that indication.

### BRIEF DESCRIPTION OF THE INVENTION

The present invention is a parameter value indicator for a parameter-measuring device, such as a temperature indicator for a thermometer. This indicator can be fabricated integrally with the sensor portion of the measuring device, or can be a separate component that can even be disposed remotely from the sensor portion. The indicator receives a signal or physical indication of a measured parameter from the sensor, and provides an indication of a range of the parameter that was measured. The indicator can be included in a display that shows the actual read parameter as well. Thus, if the sensed parameter falls outside of a normal range, the indicator can provide an indication, such as an auditory or visual signal, that the sensed parameter is abnormal. This indication does not require the observer's complete attention, but provides the essential required information.

In general, the invention is a parameter value indication apparatus for a parameter measuring device. The apparatus includes an input port, a comparator, and a parameter value indicator. The input port receives parameter value information. The comparator compares the parameter value information with a stored threshold value and generates a first comparison result if the parameter value information is below the stored threshold value and a second comparison result if the parameter value information is above the stored threshold value. For example, the threshold can cover a range from a minimum threshold value of the parameter to a maximum threshold value of the parameter. The parameter value indicator provides a non-quantitative indication of the first and second comparison results.

For example, the parameter value indicator can provide an auditory indication of a change in comparison result. The indication, for example, can be a change in tone of an auditory signal, or a change in amplitude level of an auditory signal. In the latter case, a pre-indication amplitude level of the auditory signal can be zero, such as when the auditory signal is only present when the comparison result changes.

Alternatively, or in addition, the parameter value indicator can provide a visual indication of a change in comparison result. In this case, the parameter value indication apparatus can also include an illumination device that provides the visual indication. For example, the visual indication can be a change in color of illumination generated by the illumination device. The pre-indication visual indication can be uncolored illumination that becomes colored illumination as the visual indication, or the color of the illumination generated by the illumination device can change, such as from green illumination to red illumination. Alternatively, the visual indication can be a change in intensity of illumination generated by the illumination device. The pre-indication visual indication can be illumination having an intensity of zero, that is, it can be the case that the illumination is only present to indicate a change of comparison result, or the intensity can alternate between dim and bright. As another alternative, the visual indication can correspond to a flashing of the illumination generated by the illumination device. For example, the illumination can alternate between steady and flashing, or the visual indication can be a change in a rate of the flashing.

The input port can be adapted to receive temperature information, such as a temperature value.

According to another aspect of the invention, a temperature display for a temperature-reading device can include the parameter value indication apparatus described above. The temperature display can include, for example, an LCD array, and the parameter value indicator can be an illumination device that provides back-lighting for the LCD array, or the parameter value indicator can be any back-lighting substrate for the LCD array.

According to another aspect of the invention, a thermometer can include the parameter value indicator described above. The thermometer can also include the temperature display described above, such as if the temperature display includes the parameter value indicator, although the parameter value indicator and the temperature display can be included separately, and even remote from each other, in the thermometer. The thermometer can also include a temperature sensor, which can be adapted, for example, for oral use or rectal use, and which can include an antibacterial treatment.

### BRIEF DESCRIPTION OF THE DRAWINGS

FIG. 1 is a block diagram of an exemplary parameter value indication apparatus of the present invention.

FIG. 2 is a block diagram of an exemplary audio embodiment of the invention.

FIG. 3 is a block diagram of an exemplary visual embodiment of the invention.

FIG. 4 is a block diagram of an exemplary temperature value indication embodiment of the invention.

FIG. 5 is a block diagram of an exemplary thermometer embodiment of the invention.

FIG. 6 is a block diagram of an exemplary thermometer embodiment of the invention.

### DETAILED DESCRIPTION OF THE INVENTION

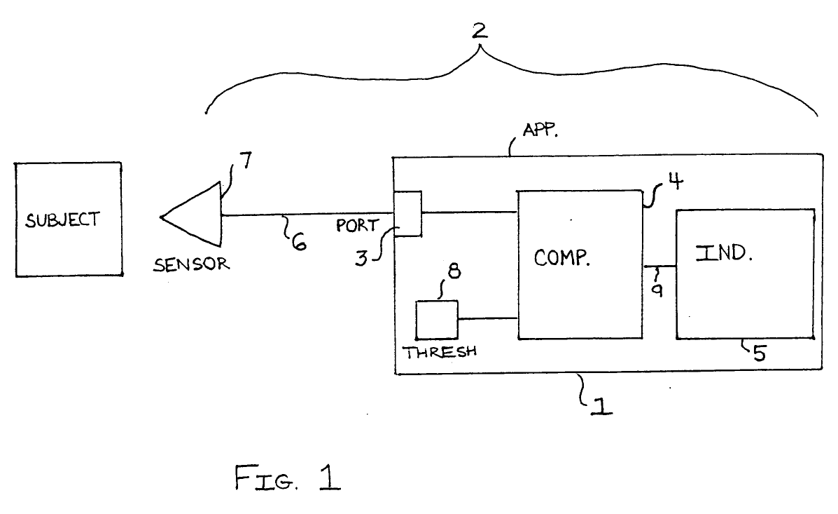

As shown in FIG. 1, a parameter value indication apparatus 1 for a parameter-measuring device 2 includes an input port 3, a comparator 4, and a parameter value indicator 5. The input port 3 receives parameter value information 6 from a sensor 7, which senses the parameter of the subject. The comparator 4 compares the parameter value information 6 with a stored threshold value 8 and generates a first comparison result if the parameter value information 6 is below the stored threshold value 8 and a second comparison result if the parameter value information 6 is above the stored threshold value 8. The threshold 8 can be a single value, or can cover a range from a minimum threshold value of the parameter to a maximum threshold value of the parameter. The parameter value indicator 5 receives the comparison result 9 and provides a non-quantitative indication of the first and second comparison results to an observer.

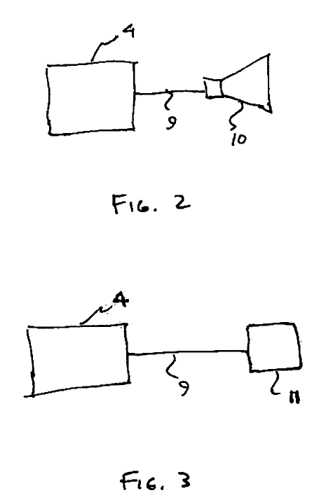

As shown in FIG. 2, the parameter value indicator 5 can be an audio speaker 10, or some other device that provides an auditory indication in response to the comparison result 9 or to a change in the comparison result 9. Thus, when the comparator 4 indicates that the parameter value information has crossed the threshold, the comparison result 9 changes, prompting the audio speaker 10 to produce sound indicative of the change. For example, as long as the parameter value information has not crossed the threshold, the comparison result 9 can cause the audio speaker 10 to emit a low-amplitude sound, or no sound at all. When the parameter value information exceeds the threshold, the comparison result 9 can cause the audio speaker 10 to emit a louder sound, or to first emit a sound. Alternatively, while the comparator 4 is receiving parameter value information that does not exceed the threshold, the comparison result 9 can cause the audio speaker 10 to emit a sound having a first tone. When the parameter value information exceeds the threshold, the comparison result 9 can cause the audio speaker 10 to emit a sound having a different tone. The electronics necessary to make the change in tone can be provided on the audio speaker 10 itself, or can be included in an intermediary circuit. Of course, the audio speaker 10 and any necessary tone- or amplitude-changing effects can be provided in software, and need not be hardware devices.

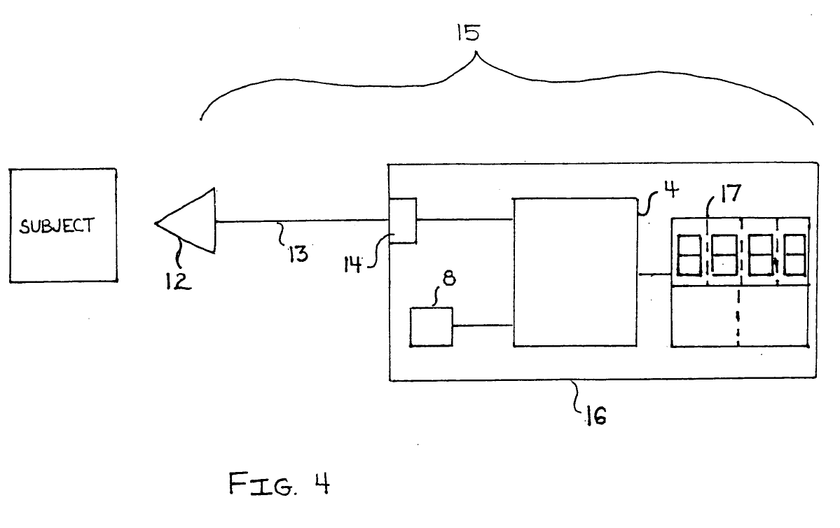

As shown in FIG. 3, the parameter value indicator 5 can be an illumination device 11, or some other device that provides a visual indication in response to the comparison result 9 or to a change in the comparison result 9. Thus, when the comparator 4 indicates that the parameter value information has crossed the threshold, the comparison result 9 changes, prompting the illumination device 11 to produce light indicative of the change. For example, as long as the parameter value information has not crossed the threshold, the comparison result 9 can cause the illumination device 11 to produce a low-level light, or no light at all. When the parameter value information exceeds the threshold, the comparison result 9 can cause the illumination device 11 to produce brighter light, or to first produce light. Alternatively, while the comparator 4 is receiving parameter value information that does not exceed the threshold, the comparison result 9 can cause the illumination device 11 to produce light having a first color (for example, green, or uncolored (unfiltered) light). When the parameter value information exceeds the threshold, the comparison result 9 can cause the illumination device 11 to produce light having a different color (red, for example). Alternatively, or additionally, while the comparator 4 is receiving parameter value information that does not exceed the threshold, the comparison result 9 can cause the illumination device 11 to produce light having a steady illumination, or flashing at a first flashing rate. When the parameter value information exceeds the threshold, the comparison result 9 can cause the illumination device 11 to produce light that flashes for the first time, or that flashes at a different rate. The electronics necessary to make the change in intensity, color, or flash rate can be provided on the illumination device 11 itself, or can be included in an auxiliary circuit.

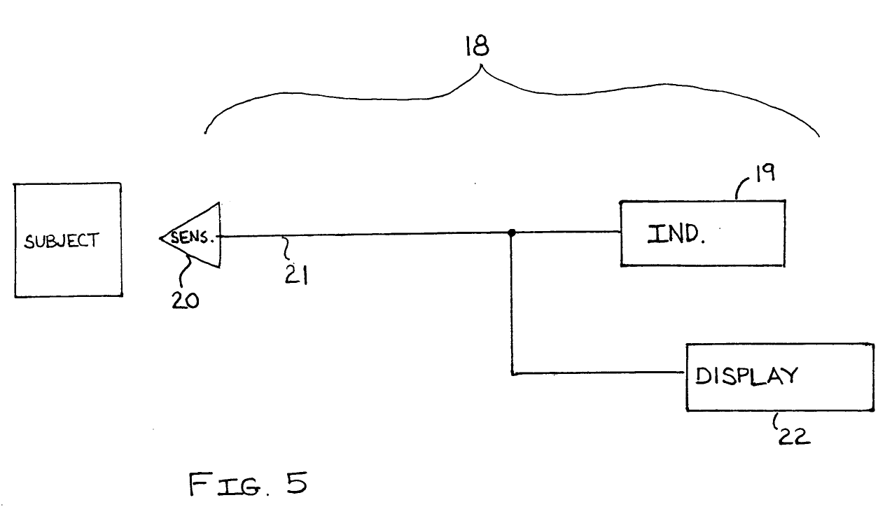

In an exemplary embodiment of the invention shown in FIG. 4, the sensor is a temperature sensor 12, and the input port 14 is adapted to receive temperature information 13 from the temperature sensor 12. Thus, the parameter that is sensed is a temperature value. The temperature-reading device 15 of this embodiment includes a temperature value indication apparatus 16 that displays an indication of a sensed temperature on a temperature value indicator 17. For example, this temperature value display can include an LCD array that provides a numerical indication of the temperature value, as with a conventional thermometer. In this case, however, the temperature value indicator 17 can be an illumination device that provides back-lighting for the LCD array, such as a back-lighting substrate for the array.

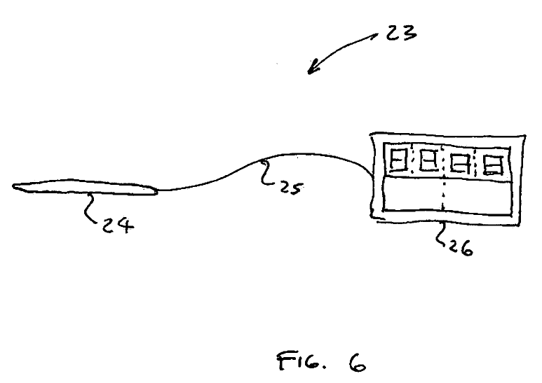

FIG. 5 shows a block diagram of an exemplary thermometer 18 that makes use of the indicator 19 of the present invention. As shown, the thermometer 18 includes a temperature sensor 20 that provides a signal 21 corresponding to the sensed temperature of the subject. The indicator 19 receives this signal and compares it to a threshold value (preferably settable by a user) indicating a boundary of the normal temperature range. For example, the threshold can correspond to a temperature that indicates a fever, that is, a higher than normal temperature. A second threshold can be used to indicate a reading that exceeds the normal range on the opposite boundary, for example, a lower than normal temperature. When a threshold is exceeded, the indicator 19 will indicate the event. For example, the indicator 19 can sound a tone when the threshold is exceeded, or can change from a first tone or sound level to a second tone or sound level. Likewise, the indicator 19 can emit a light when the threshold is exceeded, or can change the color or intensity of the light from a first value to a second value. Optionally, the actual temperature value can be shown on a display 22, which can be fabricated integrally with the indicator, or which can be a separate module as shown in the embodiment of FIG. 5.

In preferred embodiments, a stable reading of the temperature will be sensed before the indicator 19 will provide range information. For example, a fixed amount of time at a sensed temperature might be required to elapse before a threshold determination is made or reported.

FIG. 6 is a block diagram of another exemplary embodiment of the present invention. A thermometer 23 includes a sensor 24 that provides a sensed temperature signal 25 to a combination display/indicator 26. The display/indicator 26 receives the sensed temperature signal 25 and converts the signal for display on the display portion, which in this example is an LCD display. Appropriate LCD segments are activated to provide a numerical indication of the actual read temperature. The indicator portion in this example is the back-lighting substrate of the LCD segments. For purposes of this example, this back-lighting substrate will be illuminated in a first color, green for example, when the sensed temperature is within the normal range for human body temperature. If the threshold is exceeded on the upper end of the range, the back-lighting substrate will be illuminated in a second color, red for example. Thus, determining whether the sensed temperature exceeds the normal range requires less of the observer's attention than does reading the actual temperature. Optionally, the back-lighting substrate can flash the illumination when the threshold is exceeded, for emphasis. The observer can then pay closer attention to the actual temperature, if desired.

The indicator of this exemplary embodiment can be modified to include a lower-end threshold as well, or instead, which can provide illumination in a third color, blue for example, to indicate a sensed temperature is below the normal range for human body temperature. Further, when a threshold is exceeded, the change in illumination can be accompanied by the sounding of a momentary or continuous tone, for additional emphasis.

The indicator of this exemplary embodiment of the present invention is intended for use with any type of thermometer for measuring body temperature, such as oral and rectal thermometers. Generally, the indicator is intended for use with any thermometer for use to test temperature within, above, or below a particular temperature range or threshold. Enhancements to other aspects of the thermometer, such as antibacterial treatment for the sensor end by application, coating, or any other means, will not affect the performance of the indicator and are contemplated for combination with the indicator as part of a novel thermometer assembly.

Particular exemplary embodiments of the present invention have been described in detail. These exemplary embodiments are illustrative of the inventive concept recited in the appended claims, and are not limiting of the scope or spirit of the present invention as contemplated by the inventor.

1. A parameter value indication apparatus for a parameter measuring device, comprising:
an input port that receives parameter value information;
a comparator that compares the parameter value information with a stored threshold value and generates a first comparison result if the parameter value information is below the stored threshold value and a second comparison result if the parameter value information is above the stored threshold value; and
a parameter value indicator that provides a non-quantitative indication of the first and second comparison results.

2. The parameter value indication apparatus of claim 1, wherein the threshold covers a range from a minimum threshold value of the parameter to a maximum threshold value of the parameter.

3. The parameter value indication apparatus of claim 1, wherein the parameter value indicator provides an auditory indication of a change in comparison result.

4. The parameter value indication apparatus of claim 3, wherein the indication is a change in tone of an auditory signal.

5. The parameter value indication apparatus of claim 3, wherein the indication is a change in amplitude level of an auditory signal.

6. The parameter value indication apparatus of claim 5, wherein a pre-indication amplitude level of the auditory signal is zero.

7. The parameter value indication apparatus of claim 1, wherein the parameter value indicator provides a visual indication of a change in comparison result.

8. The parameter value indication apparatus of claim 7, further comprising an illumination device, wherein the illumination device provides the visual indication.

9. The parameter value indication apparatus of claim 8, wherein the visual indication is a change in color of illumination generated by the illumination device.

10. The parameter value indication apparatus of claim 9, wherein a pre-indication visual indication is uncolored illumination.

11. The parameter value indication apparatus of claim 9, wherein the change in color of illumination generated by the illumination device is a change from green illumination to red illumination.

12. The parameter value indication apparatus of claim 7, wherein the visual indication is a change in intensity of illumination generated by the illumination device.

13. The parameter value indication apparatus of claim 12, wherein the pre-indication visual indication is illumination having an intensity of zero.

14. The parameter value indication apparatus of claim 7, wherein the visual indication corresponds to a flashing of the illumination generated by the illumination device.

15. The parameter value indication apparatus of claim 14, wherein the visual indication is a change in a rate of the flashing.

16. The parameter value indication apparatus of claim 1, wherein the input port is adapted to receive temperature information.

17. The parameter value indication apparatus of claim 16, wherein the parameter is a temperature value.

18. A temperature display for a temperature-reading device, including the parameter value indication apparatus of claim 1.

19. The temperature display of claim 18, including an LCD array.

20. The temperature display of claim 19, wherein the parameter value indicator is an illumination device that provides back-lighting for the LCD array.

21. The temperature display of claim 20, wherein the parameter value indicator is a back-lighting substrate for the LCD array.

22. A thermometer that includes the parameter value indicator of claim 1.

23. The thermometer of claim 22, further including the temperature display of claim 17.

24. The thermometer of claim 23, wherein the temperature display includes the parameter value indicator.

25. The thermometer of claim 22, further including a temperature sensor.

26. The thermometer of claim 25, wherein the temperature sensor is adapted for oral use.

27. The thermometer of claim 25, wherein the temperature sensor is adapted for rectal use.

28. The thermometer of claim 25, wherein the temperature sensor includes an antibacterial treatment.
